(19) United States
(12) Patent Application Publication
(10) Pub. No.: US 2025/0374299 A1
(43) Pub. Date: Dec. 4, 2025

(54) ENERGY-BASED SENSING PARAMETERS FOR A SIDELINK RESOURCE POOL

(71) Applicant: QUALCOMM INCORPORATED, San Diego, CA (US)

(72) Inventors: Ahmed Elshafie, San Diego, CA (US); Seyedkianoush Hosseini, San Diego, CA (US); Yuchul Kim, San Diego, CA (US); Linhai He, San Diego, CA (US); Zhikun Wu, Beijing (CN); Huilin Xu, Temecula, CA (US); Krishna Kiran Mukkavilli, San Diego, CA (US); Tingfang Ji, San Diego, CA (US)

(21) Appl. No.: 18/877,903

(22) PCT Filed: Aug. 10, 2022
(86) PCT No.: PCT/CN2022/111382

§ 371 Date: Dec. 20, 2024

(51) Int. Cl. H04W 72/25; H04W 52/02

(52) U.S. Cl. CPC H04W 72/25; H04W 52/0235

(57) ABSTRACT

Methods, systems, and devices for wireless communication are described to support respective timing parameters for corresponding energy classes or power states of energy-harvesting user equipments (UEs). An energy-harvesting UE may receive an indication of a sidelink resource pool and one or more timing parameters associated with an energy class or power state of the UE. In some cases, the indication may indicate for the UE to communicate without performing sensing, for example, if the UE has a low energy-harvesting capability or low power. In some cases, the indication may define timing parameters for channel sensing, where the timing parameters may be associated with a respective energy class, power state, or combination thereof. Based on determining whether to perform channel, the UE may select a resource for a sidelink message and may transmit the sidelink message using the resource.

### CROSS REFERENCE

The present Application is a 371 national stage filing of International PCT Application No. PCT/CN2022/111382 by Elshafie et al. entitled “ENERGY-BASED SENSING PARAMETERS FOR A SIDELINK RESOURCE POOL,” filed Aug. 10, 2022, which is assigned to the assignee hereof, and which is expressly incorporated by reference in its entirety herein.

### TECHNICAL FIELD

The following relates to generally to wireless communication, including energy-based sensing parameters for a sidelink resource pool.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may communicate with one or more other UEs over sidelink communication links. In some cases, a network entity may allocate resources for sidelink communications between the UEs. In other cases, the UEs may autonomously select the sidelink resources.

### SUMMARY

The described techniques relate to improved methods, systems, devices, and apparatuses that support energy-based sensing parameters for a sidelink resource pool. For example, the described techniques support respective sidelink sensing parameters (e.g., timing parameters) for corresponding energy classes (e.g., energy-harvesting device classes) or power states (e.g., energy states) of energy-harvesting user equipments (UEs). Accordingly, an energy-harvesting UE may receive an indication of a sidelink resource pool and one or more timing parameters associated with an energy class or power state of the UE. In some cases, the indication may indicate for the UE (e.g., the energy class or power state of the UE) to communicate without performing sensing, for example, if the UE has a low energy-harvesting capability or low power. Additionally or alternatively, the indication may define channel sensing parameters (e.g., timing parameters) associated with a respective energy class, power state (e.g., low power state, partial power state, high power state), or combination thereof. Based on determining whether to perform channel sensing (e.g., and in some cases based on the results of the channel sensing), the UE may select a resource for a sidelink message and may transmit the sidelink message using the resource.

A method for wireless communication at a user equipment (UE) is described. The method may include receiving, from a network entity, an indication of a sidelink resource pool and one or more timing parameters that correspond to an energy class or a power state of the UE, the one or more timing parameters associated with performing channel sensing within the sidelink resource pool, selecting, based on the one or more timing parameters, between a first channel sensing mode in which the UE is triggered to monitor the sidelink resource pool to perform channel sensing and a second channel sensing mode in which the UE is exempted from channel sensing, and transmitting, to a second UE, a sidelink message via a resource of the sidelink resource pool, the resource selected based on selecting between the first channel sensing mode and the second channel sensing mode.

An apparatus for wireless communication at a UE is described. The apparatus may include at least one processor, memory coupled with the at least one processor, and the memory storing instructions. The instructions may be executable by the at least one processor to cause the UE to receive, from a network entity, an indication of a sidelink resource pool and one or more timing parameters that correspond to an energy class or a power state of the UE, the one or more timing parameters associated with performing channel sensing within the sidelink resource pool, select, based on the one or more timing parameters, between a first channel sensing mode in which the UE is triggered to monitor the sidelink resource pool to perform channel sensing and a second channel sensing mode in which the UE is exempted from channel sensing, and transmit, to a second UE, a sidelink message via a resource of the sidelink resource pool, the resource selected based on selecting between the first channel sensing mode and the second channel sensing mode.

Another apparatus for wireless communication at a UE is described. The apparatus may include means for receiving, from a network entity, an indication of a sidelink resource pool and one or more timing parameters that correspond to an energy class or a power state of the UE, the one or more timing parameters associated with performing channel sensing within the sidelink resource pool, means for selecting, based on the one or more timing parameters, between a first channel sensing mode in which the UE is triggered to monitor the sidelink resource pool to perform channel sensing and a second channel sensing mode in which the UE is exempted from channel sensing, and means for transmitting, to a second UE, a sidelink message via a resource of the sidelink resource pool, the resource selected based on selecting between the first channel sensing mode and the second channel sensing mode.

A non-transitory computer-readable medium storing code for wireless communication at a UE is described. The code may include instructions executable by at least one processor to receive, from a network entity, an indication of a sidelink resource pool and one or more timing parameters that correspond to an energy class or a power state of the UE, the one or more timing parameters associated with performing channel sensing within the sidelink resource pool, select, based on the one or more timing parameters, between a first channel sensing mode in which the UE is triggered to monitor the sidelink resource pool to perform channel sensing and a second channel sensing mode in which the UE is exempted from channel sensing, and transmit, to a second UE, a sidelink message via a resource of the sidelink resource pool, the resource selected based on selecting between the first channel sensing mode and the second channel sensing mode.

In some examples of the method, apparatuses, and non-transitory computer-readable medium described herein, receiving the indication of the one or more timing parameters may include operations, features, means, or instructions for receiving an indication of a first energy class, a first power state, or both, that may be associated with the second channel sensing mode in which the UE may be exempted from channel sensing for selecting resources of the sidelink resource pool.

In some examples of the method, apparatuses, and non-transitory computer-readable medium described herein, the first energy class may be one of a set of multiple defined energy classes and the first energy class may be associated with a lower capability for energy harvesting than one or more other energy classes of the set of multiple defined energy classes and the first power state may be one of a set of multiple defined power states and the first power state may be associated with a lower available power than one or more other power states of the set of multiple defined power states.

In some examples of the method, apparatuses, and non-transitory computer-readable medium described herein, receiving the indication of the one or more timing parameters may include operations, features, means, or instructions for receiving an indication of a first duration of a first time period between a beginning of a time window for performing channel sensing and a time at which resource selection within the sidelink resource pool may be triggered.

In some examples of the method, apparatuses, and non-transitory computer-readable medium described herein, the one or more timing parameters indicate a set of multiple durations each corresponding to a respective duration for the first time period and each associated with a respective energy class or power state, the set of multiple durations including the first duration.

In some examples of the method, apparatuses, and non-transitory computer-readable medium described herein, receiving the indication of the one or more timing parameters may include operations, features, means, or instructions for receiving an indication of a second duration associated with a second time period between a time at which resource selection within the sidelink resource pool may be triggered and an end of a time window in which resources of the sidelink resource pool may be selected.

In some examples of the method, apparatuses, and non-transitory computer-readable medium described herein, the one or more timing parameters indicate a second set of multiple durations each associated with a respective duration for the second time period and each associated with a respective energy class or power state, the second set of multiple durations including the second duration.

In some examples of the method, apparatuses, and non-transitory computer-readable medium described herein, receiving the indication of the one or more timing parameters may include operations, features, means, or instructions for receiving an indication of a first energy class, a first power state, or both, that may be associated with the second channel sensing mode in which the UE may be exempted from performing measurements for determining a channel usage ratio within the sidelink resource pool.

In some examples of the method, apparatuses, and non-transitory computer-readable medium described herein, receiving the indication of the one or more timing parameters may include operations, features, means, or instructions for receiving an indication of a third duration of a third time period associated with performing measurements for determining a channel usage ratio.

In some examples of the method, apparatuses, and non-transitory computer-readable medium described herein, the one or more timing parameters indicate a set of multiple durations each corresponding to a respective duration for the third time period and each associated with a respective energy class or power state, the set of multiple durations including the third duration.

Some examples of the method, apparatuses, and non-transitory computer-readable medium described herein may further include operations, features, means, or instructions for receiving, from a second UE, a second indication of one or more channel usage measurements determined by the second UE, a result of channel sensing performed by the second UE and associated with resource selection from the sidelink resource pool, or both, where selecting the resource for transmitting the sidelink message may be based on receiving the second indication.

Some examples of the method, apparatuses, and non-transitory computer-readable medium described herein may further include operations, features, means, or instructions for receiving, from the network entity or from a third UE, an identifier indicating the second UE, the identifier indicating that the second UE may be configured to send the second indication to the UE, where receiving the second indication from the second UE may be based on receiving the identifier indicating the second UE.

Some examples of the method, apparatuses, and non-transitory computer-readable medium described herein may further include operations, features, means, or instructions for transmitting, to the second UE, a request for the second UE to send the second indication to the UE, where receiving the second indication from the second UE may be based on transmitting the request.

In some examples of the method, apparatuses, and non-transitory computer-readable medium described herein, receiving the second indication from the second UE may include operations, features, means, or instructions for receiving, from the second UE, a set of multiple indications each indicating one or more respective channel usage measurements determined by the second UE, a respective result of channel sensing performed by the second UE and associated with resource selection from the sidelink resource pool, or both, where the set of multiple indications includes the second indication.

In some examples of the method, apparatuses, and non-transitory computer-readable medium described herein, the second UE may be associated with a same zone identifier as the UE, may be in a radio resource control connected state with the UE, or both.

In some examples of the method, apparatuses, and non-transitory computer-readable medium described herein, the power state of the UE may be associated with a current available power at the UE, a current charging rate of the UE, a current powered down state of the UE, or any combination thereof.

In some examples of the method, apparatuses, and non-transitory computer-readable medium described herein, the energy class of the UE may be associated with a class of energy harvesting performed by the UE.

A method for wireless communication at a second UE is described. The method may include receiving a first indication to send, to a first UE, a second indication of one or more channel usage measurements determined by the second UE, a result of channel sensing performed by the second UE and associated with resource selection from a sidelink resource pool, or both and transmitting, to the first UE and based on receiving the first indication, the second indication including the one or more channel usage measurements determined by the second UE, the result of the channel sensing performed by the second UE and associated with resource selection from the sidelink resource pool, or both.

An apparatus for wireless communication at a second UE is described. The apparatus may include at least one processor, memory coupled with the at least one processor, and the memory storing instructions. The instructions may be executable by the at least one processor to cause the second UE to receive a first indication to send, to a first UE, a second indication of one or more channel usage measurements determined by the second UE, a result of channel sensing performed by the second UE and associated with resource selection from a sidelink resource pool, or both and transmit, to the first UE and based on receiving the first indication, the second indication including the one or more channel usage measurements determined by the second UE, the result of the channel sensing performed by the second UE and associated with resource selection from the sidelink resource pool, or both.

Another apparatus for wireless communication at a second UE is described. The apparatus may include means for receiving a first indication to send, to a first UE, a second indication of one or more channel usage measurements determined by the second UE, a result of channel sensing performed by the second UE and associated with resource selection from a sidelink resource pool, or both and means for transmitting, to the first UE and based on receiving the first indication, the second indication including the one or more channel usage measurements determined by the second UE, the result of the channel sensing performed by the second UE and associated with resource selection from the sidelink resource pool, or both.

A non-transitory computer-readable medium storing code for wireless communication at a second UE is described. The code may include instructions executable by at least one processor to receive a first indication to send, to a first UE, a second indication of one or more channel usage measurements determined by the second UE, a result of channel sensing performed by the second UE and associated with resource selection from a sidelink resource pool, or both and transmit, to the first UE and based on receiving the first indication, the second indication including the one or more channel usage measurements determined by the second UE, the result of the channel sensing performed by the second UE and associated with resource selection from the sidelink resource pool, or both.

Some examples of the method, apparatuses, and non-transitory computer-readable medium described herein may further include operations, features, means, or instructions for receiving, from a network entity or from a third UE, an identifier indicating the first UE, the identifier indicating that the first UE may be configured to receive the second indication from the second UE, where transmitting the second indication to the first UE may be based on receiving the identifier indicating the first UE.

In some examples of the method, apparatuses, and non-transitory computer-readable medium described herein, receiving the first indication may include operations, features, means, or instructions for receiving, from the first UE, a request for the second UE to send the second indication to the first UE, where transmitting the second indication to the first UE may be based on receiving the request.

In some examples of the method, apparatuses, and non-transitory computer-readable medium described herein, transmitting the second indication to the first UE may include operations, features, means, or instructions for transmitting, to the first UE, a set of multiple indications each indicating one or more respective channel usage measurements determined by the second UE, a respective result of channel sensing performed by the second UE and associated with resource selection from the sidelink resource pool, or both, where the set of multiple indications includes the second indication.

In some examples of the method, apparatuses, and non-transitory computer-readable medium described herein, the second UE may be associated with a same zone identifier as the first UE, may be in a radio resource control connected state with the first UE, or both.

In some examples of the method, apparatuses, and non-transitory computer-readable medium described herein, the first UE may be an energy harvesting UE and receiving the first indication may be based on an energy harvesting class or a power state of the first UE.

### BRIEF DESCRIPTION OF THE DRAWINGS

FIG. 1 illustrates an example of a wireless communications system that supports energy-based sensing parameters for a sidelink resource pool in accordance with one or more aspects of the present disclosure.

FIG. 2 illustrates an example of a wireless communications system that supports energy-based sensing parameters for a sidelink resource pool in accordance with one or more aspects of the present disclosure.

FIG. 3 illustrates an example of a timing diagram that supports energy-based sensing parameters for a sidelink resource pool in accordance with one or more aspects of the present disclosure.

FIG. 4 illustrates an example of a process flow that supports energy-based sensing parameters for a sidelink resource pool in accordance with one or more aspects of the present disclosure.

FIGS. 5 and 6 show block diagrams of devices that support energy-based sensing parameters for a sidelink resource pool in accordance with one or more aspects of the present disclosure.

FIG. 7 shows a block diagram of a communications manager that supports energy-based sensing parameters for a sidelink resource pool in accordance with one or more aspects of the present disclosure.

FIG. 8 shows a diagram of a system including a device that supports energy-based sensing parameters for a sidelink resource pool in accordance with one or more aspects of the present disclosure.

FIGS. 9 through 12 show flowcharts illustrating methods that support energy-based sensing parameters for a sidelink resource pool in accordance with one or more aspects of the present disclosure.

### DETAILED DESCRIPTION

In some wireless communication systems, a user equipment (UE) may operate in a mode 1 or mode 2 for performing sidelink communications with another UE. For example, the UE may autonomously select sidelink resources when operating in mode 2 of sidelink. In this mode, UEs may sense available resources and select a resource for transmission from the available resources. The resource selection process may be defined by several parameters including time intervals during which the UE may sense resource selection indications from other UEs, process sensing results, select a resource for transmission, and transmit. In some cases, an energy-harvesting device may be an example of a sidelink UE.

In some cases, an energy-harvesting device (e.g., some types or classes of energy-harvesting devices) may perform channel sensing and resource selection over a longer time duration than a non-energy-harvesting device (e.g., UE) because the energy-harvesting device may recharge during the channel sensing and resource selection process. Similarly, one class of energy-harvesting device may use a longer time duration to sense the available resources than another class of energy-harvesting devices (e.g., due to an energy-harvesting device consuming more power during sensing or having a slower charging rate). Similarly, a device in a first power state (e.g., current charging rate, current discharging rate, current available power, current power status) may use a longer time duration to sense the available resources than another device in a second power state. However, the parameters associated with the resource selection process may be the same for all UEs, regardless of class or power state.

To support a more reliable and efficient method of selecting sidelink resources, a network entity may define respective sidelink sensing parameters (e.g., timing parameters) for corresponding energy classes or power states of UEs (e.g., energy-harvesting UEs). As described herein, an energy class may be or represent a type or class of energy-harvesting device. Additionally or alternatively, an energy class may be associated with a type of energy-harvesting performed by a UE (e.g., an energy-harvesting capability), a charging rate or energy harvesting rate associated with the UE (e.g., minimum rate, average rate, expected rate, nominal rate, default rate), a discharging rate or energy consumption rate associated with the UE (e.g., minimum rate, average rate, expected rate, nominal rate, default rate), an energy-harvesting technology used by the UE, a size (e.g., maximum size) of an energy storage unit of the UE (e.g., a battery or supercapacitor of the UE), or any combination thereof (e.g., among other examples).

As described herein, a power state (e.g., energy state) of a UE may represent an amount of power or energy available to the UE, a current discharging rate of the UE, a current charging rate of the UE, a mode in which the UE is operating (e.g., a low-power mode, a sleep mode, a powered-down mode), a communication mode of the UE (e.g., a mode that is ready for data communication, control communication, or a combination thereof in the uplink and/or downlink), or any combination thereof (e.g., among other examples). In some cases, a power state may be associated with a sensing capability and/or sensing parameters of a UE (e.g., as based on, or associated with, the current charging rate, current discharging rate, and/or available power).

An energy-harvesting UE may receive an indication of a sidelink resource pool and one or more timing parameters associated with an energy class or power state of the UE. In some cases, the indication may indicate for the UE (e.g., the energy class or power state of the UE) to communicate without performing sensing, for example, if the UE has a low energy-harvesting capability or low power. Additionally or alternatively, the indication may define channel sensing parameters (e.g., timing parameters) associated with a respective energy class, power state (e.g., low power state, partial power state, high power state), or combination thereof.

In some cases (e.g., if a UE is exempt from channel sensing), an energy-harvesting UE may be paired with a helper UE (e.g., non-energy-harvesting UE), which may perform channel sensing or measurements on behalf of the energy-harvesting UE. Based on determining whether to perform channel sensing (e.g., and in some cases based on the results of the channel sensing), the UE may select a resource for a sidelink message and may transmit the sidelink message using the resource.

Aspects of the disclosure are initially described in the context of wireless communications systems. A timing diagram and process flow are provided to describe aspects of the disclosure. Aspects of the disclosure are further illustrated by and described with reference to apparatus diagrams, system diagrams, and flowcharts that relate to energy-based sensing parameters for a sidelink resource pool.

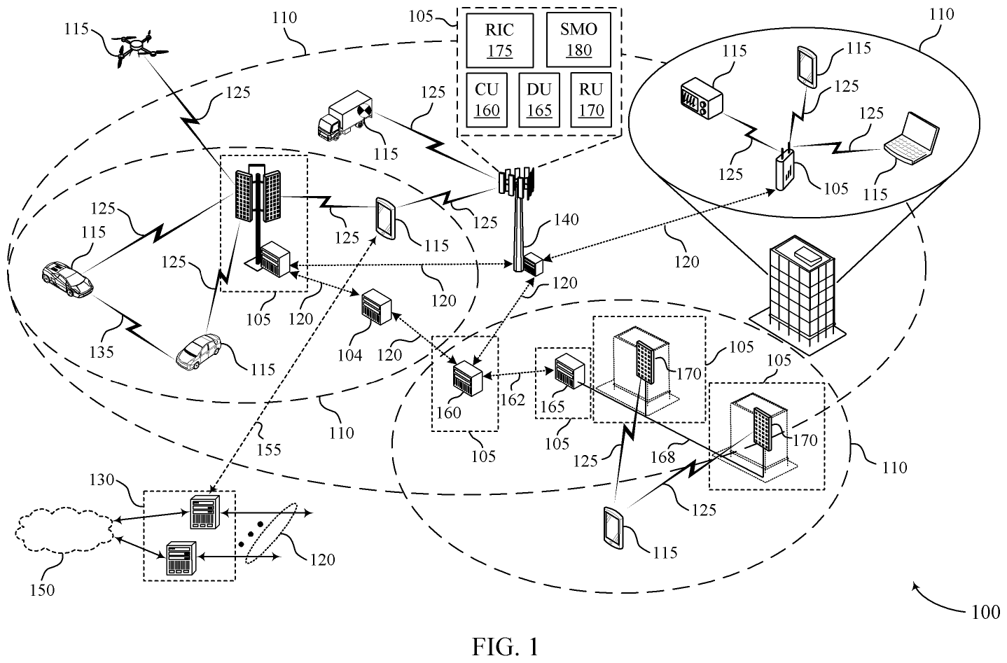

FIG. 1 illustrates an example of a wireless communications system 100 that supports energy-based sensing parameters for a sidelink resource pool in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support energy-based sensing parameters for a sidelink resource pool as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless communications systems (e.g., such as wireless communications system 100) may include energy-harvesting devices, such as UEs 115 or other devices, that may be operable to wirelessly harvest energy (e.g., from the environment) that may be used by the respective devices to perform wireless communications, or perform other operations. The harvested energy may be stored in a rechargeable battery or a supercapacitor associated with the UE 115 or device. Some energy-harvesting devices may support different types and/or sources of energy-harvesting. For example, some energy-harvesting devices may be able to extract energy from sources such as thermal sources, solar sources, vibration sources, motion sources, RF sources, light-based sources such as lasers, other sources, or any combination thereof. If an energy-harvesting UE 115 (e.g., an energy receiver device) does not have enough energy for communications or other operations, the energy-harvesting UE may engage in an energy-harvesting procedure to accumulate energy for the communications or the other operations.

In some implementations, an energy-harvesting device may be an example of a UE 115 that may perform sidelink communications (e.g., may communicate with one or more other UEs 115 via respective sidelink links, which may support hybrid automatic repeat request (HARQ) based retransmissions). In a sidelink mode 1, a network entity 105 may allocate resources for sidelink communications between UEs 115. In a sidelink mode 2, a UE 115 may autonomously determine (e.g., select) resources for sidelink communications (e.g., independent of a network entity 105). For example, a UE 115 operating according to mode 2 may perform channel sensing for sidelink channels to detect sidelink channel occupancy. In some examples, the UE 115 may blindly decode signals (e.g., sidelink control information (SCI)) sent via one or more physical sidelink control channels (PSCCHs). Based on the decoding, the UE 115 may detect reserved resources for other sidelink transmissions. The UE 115 may, for example, determine available resources within a sidelink resource pool and may perform resource reservation based on the available resources for the sidelink channels of the sidelink resource pool.

In some cases, when operating in accordance with the sidelink mode 2, the UE 115 may reserve sidelink resources based on sensing sidelink information from other UEs 115 in the wireless communications system 100. The UE 115 may determine resource reservations from the other UEs 115 by decoding SCI transmitted by the other UEs 115. The UE 115 may decode SCI within a sensing window, where a time dimension (e.g., time duration, length) of the sensing window may be configured or pre-configured for the resource pool, for the UE 115, or both. A UE 115, such as a transmitter UE 115, may decode SCI from other UEs 115 in the wireless communications system 100. The SCI may indicate reserved resources associated with future sidelink transmission occasions (e.g., future slots) and may also indicate a priority of the associated sidelink transmission(s). Based on the decoded SCI (e.g., the resource reservation, the priority, both), the UE 115 may determine candidate sidelink resources associated with a sidelink resource selection window (e.g., resources within the resource selection window, future available resources).

The UE 115 may determine, based on the decoded SCI and, in some cases, based on reference signal received power (RSRP) measurements, a set of candidate sidelink resources associated with the sidelink resource selection window. In some cases, the UE may measure RSRP on a PSCCH demodulation reference signal (DMRS) or physical sidelink shared channel (PSSCH) DMRS, according to a configuration (e.g., a pre-configuration, signaled configuration) for the UE 115, the sidelink resource pool, or both. The candidate sidelink resources may exclude reserved sidelink resources associated with RSRP measurement values satisfying an RSRP threshold value. For example, the UE 115 may measure an RSRP associated with the decoded SCIs, and may project the RSRP onto the resource selection window (e.g., onto future resources reserved the associated SCI). Within the sidelink resource selection window sidelink resources may be considered reserved if the sidelink resources are associated with RSRP measurement values greater than or equal to an RSRP threshold value (e.g., satisfying the threshold). Similarly, sidelink resources may be considered unused or not reserved if the sidelink resources are associated with RSRP measurement values less than the RSRP threshold value (e.g., failing to satisfy the threshold).

Any unused sidelink resources (e.g., resources not indicated as reserved, reserved resources associated with a lower RSRP value) may be considered candidate resources available for selection by the UE 115 and may be reported to higher layers of a protocol stack. The UE 115 may randomly select sidelink resources from a set of candidate sidelink resources associated with the sidelink resource selection window and perform sidelink communications using the selected sidelink resources. Resources selected for retransmissions may be selected by the UE 115 such that all retransmissions may occur within a packet delay budget (PDB) associated with an initial transmission (e.g., initial packet).

In some cases, an RSRP comparison threshold may be previously configured based on a transmitting UE priority and a receiving UE priority (e.g., a priority pair). In some examples, if a proportion of available resources in the resource selection window is below a desired threshold (e.g., less than 20 percent of total resources), the UE 115 may increase the RSRP threshold and repeat the resource sensing and selecting process (e.g., which may thereby result in a larger quantity of resources being considered available or unused because an associated RSRP is below the increased RSRP threshold).

In some cases, one or more aspects of autonomously selecting the sidelink resources, such as the sensing window and the resource selection window (e.g., among other aspects) may be associated with (e.g., defined by) one or more configured timing parameters (e.g., pre-configured timing parameters, signaled timing parameters). For example, the one or more timing parameters may include one or more of a time duration from a beginning of a sensing window to a resource selection trigger (e.g., an event or process at the UE 115 that triggers resource selection), a time duration from the resource selection trigger to a beginning of a resource selection window (e.g., which may be different for different UEs 115, may be based on UE implementation or determination), a smallest (e.g., minimum) time duration from the resource selection trigger to an end of the resource selection window, or a time from determination (e.g., confirmation) of an available resource and transmission using the available resource.

As described herein, a sidelink UE 115 may, in some cases, be an energy-harvesting UE 115 (e.g., a reduced-capacity UE 115, a passive IoT UE 115). Each energy-harvesting UE 115 may be associated with a class or type of UE 115 that performs energy-harvesting (e.g., an energy class). For example, an energy-harvesting UE class or type may be characterized by one or more of a charging rate (e.g., minimum rate, average rate, expected rate, nominal rate, default rate), a discharging rate (e.g., minimum rate, average rate, expected rate, nominal rate, default rate), an energy-harvesting technology (e.g., solar, RF), or supercapacitor and/or battery size (e.g., maximum size). As describe herein, a discharging rate may include energy loss and/or leakage from an energy storage unit or battery of an energy-harvesting UE 115. In some cases, charging and discharging a battery (e.g., energy storage unit leakage) may be based on a quantity of tasks being performed by the energy-harvesting UE 115, or may be based on a power state of the UE 115 (e.g., a communication state of the UE, whether or not the UE 115 is in a sleeping mode or a power saving mode).

Because channel sensing may consume relatively large amounts of energy (e.g., resulting in an energy-harvesting UE 115 recharging between sensing the channel and processing the sensed resources) a type or class of energy-harvesting UE 115 may impact a time to perform sidelink channel sensing.

For example, a first class of energy-harvesting devices (e.g., UEs 115) may take a longer time to sense available resources than a second class of energy-harvesting devices due to consuming more power during sensing, due to having a slower charging rate, or due to having less available power. However, the one or more timing parameters associated with the resource selection process may be the same for all UEs 115, regardless of energy class or a power state (e.g., a discharge rate, a charge rate, an amount of available power, being off or on), which may result in increased latency or increased errors (e.g., among other problems) during resource selection.

To support sidelink channel sensing by energy-harvesting UEs 115, a network entity 105 may configure a resource pool and one or more parameters for channel sensing within the resource pool that are associated with a respective energy-harvesting class and/or respective power state (e.g., charging rate, amount of power). In some cases, the one or more parameters configured by the network entity 105 may indicate for an energy-harvesting UE 115 to select resources without performing channel sensing (e.g., without decoding SCI in the sensing window to determine candidate resources), such as if the UE 115 is in a low power state or is associated with a lower energy-harvesting class. In some cases where an energy-harvesting UE 115 does not perform channel sensing, the UE 115 may be paired with a helper UE 115 (e.g., a non-energy-harvesting UE 115), which may perform channel sensing or measurements on behalf of the energy-harvesting UE 115 and may transmit an indication of such measurements to the UE.

Additionally, or alternatively, the one or more parameters configured by the network entity 105 may indicate different timing parameters associated with resource selection for different classes of energy-harvesting UEs 115, for different power states associated with energy-harvesting UEs 115, or both. For example, energy-harvesting devices may perform channel sensing and channel busy ratio (CBR) or channel occupation ratio (CR) measurements, as well as SCI decoding for resource selection, based on the one or more timing parameters associated with the energy class or power state of the energy-harvesting devices (e.g., if the energy class or power state of the energy-harvesting devices are configured for channel sensing).

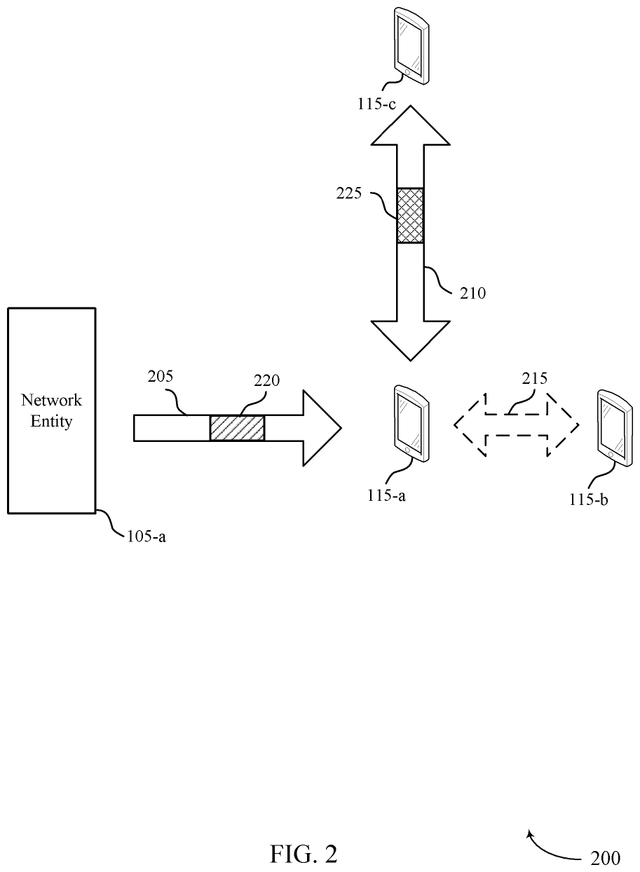

FIG. 2 illustrates an example of a wireless communications system 200 that supports energy-based sensing parameters for a sidelink resource pool in accordance with one or more aspects of the present disclosure. The wireless communications system 200 may implement or be implemented by aspects of the wireless communications system 100 as described in FIG. 1. For example, UEs 115-a, 115-b, and 115-c may be examples of a UE 115 as described with reference to FIG. 1. UE 115-a and UE 115-c may be examples of energy-harvesting devices as described in FIG. 1, while UE 115-b, and in some cases, UE 115-c may be examples of non-energy-harvesting devices. Network entity 105-a may be an example of network entity 105 as described with reference to FIG. 1. Network entity 105-a may communicate with UE 115-a via a communication link 205. UE 115-a may communicate with UE 115-c via a sidelink communication link 210 and UE 115-a may communicate with UE 115-b via a sidelink communication link 215.

UE 115-a and UE 115-c may be energy-harvesting devices belonging to a same or different energy-harvesting class. As such, UE 115-a and UE 115-c may each be associated with a respective charging rate, energy-harvesting capacity, or both, associated with their respective energy-harvesting class. UE 115-a may operate in sidelink mode 2. As such, network entity 105-a may configure (e.g., allocate) a sidelink resource pool for communications between the UEs 115 (e.g., between UE 115-a and one or more of the other UEs 115).

For example, UE 115-a may receive, from network entity 105-a, an indication 220 of a sidelink resource pool and one or more timing parameters that correspond to an energy class or a power state of UE 115-a. In some cases, the one or more timing parameters may be associated with performing channel sensing within the sidelink resource pool. The power state of UE 115-a may be associated with a current available power at UE 115-a, a current charging rate of UE 115-a, a current discharging rate of UE 115-a, a current powered down state of UE 115-a, or any combination thereof (e.g., among other examples). The energy class of UE 115-a may be an energy-harvesting UE class, and may be associated with a class of energy-harvesting performed by UE 115-a (e.g., an energy-harvesting capability of UE 115-a), a charging rate or energy harvesting rate (e.g., minimum rate, average rate, expected rate, nominal rate, default rate), a discharging rate or energy consumption rate (e.g., minimum rate, average rate, expected rate, nominal rate, default rate), an energy-harvesting technology (e.g., solar, RF), or supercapacitor and/or battery size (e.g., maximum size). The one or more parameters configured by the network entity 105-a may indicate one or more timing parameters for resource selection within the sidelink resource pool based on an energy-harvesting class and/or a power state of an energy-harvesting UE 115 (e.g., such as UE 115-a).

UE 115-a may select, based on the one or more timing parameters and the energy class or power state of UE 115-a, between a first channel sensing mode and a second channel sensing mode. In the first channel sensing mode (e.g., associated with a higher charging rate, higher power state, higher energy-harvesting capability), UE 115-a may be triggered to monitor the sidelink resource pool to perform channel sensing. In the second channel sensing mode, UE 115-a may be exempt from channel sensing (e.g., UE 115-a may perform sidelink communications without performing channel sensing). For example, UE 115-a may be exempt from performing channel sensing if UE 115-a is operating in a low power state or belongs to an energy-harvesting class with a low charging rate and low energy-harvesting capability. In some such cases, UE 115-a may select sidelink resources randomly (e.g., without performing SCI decoding and resource selection techniques described herein). UE 115-a may select a resource of the sidelink resource pool based on selecting between the first channel sensing mode and the second channel sensing mode.

For example, UE 115-a may receive an indication of one or more energy classes, power states, or both that are associated with the second channel sensing mode and may determine if UE 115-a is exempted from channel sensing based on the energy class and/or power state of UE 115-a and the energy class(es) and/or power state(s) associated with the second channel sensing mode (e.g., may be exempt if UE 115-a is associated with an energy class or power state indicated as associated with the second channel sensing mode). For example, network entity 105-a may indicate that UE 115-a may perform channel sensing in a partial power or high power state but not in a low power state.

If UE 115-a is associated with an energy class or power state not associated with the second channel sensing mode (e.g., associated with the first channel sensing mode), UE 115-a may perform channel sensing to determine and select one or more available sidelink resources from the sidelink resource pool, and may transmit a sidelink message 225 to UE 115-c via the selected resource(s) of the sidelink resource pool. If UE 115-a is associated with an energy class or power state that is associated with the second channel sensing mode, UE 115-a may refrain from performing channel sensing to determine and select one or more available sidelink resources from the sidelink resource pool. For example, UE 115-a may randomly select a resource from the sidelink resource pool (e.g., without performing channel sensing) and may transmit a sidelink message 225 to UE 115-c via the selected resource(s) of the sidelink resource pool.

For energy classes and/or power states that are associated with the first channel sensing mode (e.g., that perform channel sensing), network entity 105-a may define the channel sensing parameters (e.g., timing parameters) per power state, per energy class, or a combination thereof. In one example, the one or more parameters may indicate, regardless of class, at least three power states (e.g., power modes) for which channel sensing parameters may be defined. These three states may, for example, include a low power state, a medium or partial power state, and a high or full power state. In other examples, other quantities of power states may be defined (e.g., two power states, four power states).

In some examples, the one or more parameters may indicate power states that may include a power state that is ready for data communication (e.g., for monitoring, receiving, and decoding a control signal and a data signal), a power state that is ready for control communication (e.g., receiving and monitoring control signals, but not data signals), and a power state that is not ready for communication (e.g., not ready to monitor, receive, and/or decode control or data signaling). In some cases, the power state that is ready for data communication may include one or more sub-states, such as a sub-state associated with receiving and/or decoding data (e.g., but not transmitting data), a sub-state associated with transmitting data (e.g., but not receiving data), or a sub-state associated with both receiving and transmitting data. A power level (e.g., a maximum or fixed power level) may be associated with the one or more respective sub-states. In the downlink, supporting reception of some transport block sizes or some allocations with a quantity of resource elements (e.g., or quantity of frequency allocations and/or time allocations) may be associated with one or more respective sub-states. In some cases, a respective power state may be associated with or include a sensing capability and/or sensing parameters (e.g., as based on, or associated with, the current charging rate and/or current discharging rate).

For a respective power state, energy class, or combination thereof, network entity 105-a may disable, enlarge, or otherwise change the channel sensing parameters (e.g., timing parameters) such that the configured parameters of the sensing window may depend on the energy-harvesting class and current energy-harvesting power state. For example, network entity 105-a may support sidelink communications for multiple energy classes, multiple power states, and combinations thereof, and the one or more timing parameters indicated by network entity 105-a may be configured for respective energy classes, power states, and combinations thereof, out of the supported energy classes and power states.

In some cases, disabling (e.g., exempting) the channel sensing for one or more energy classes and/or power states may include disabling CBR measurements and CBR-based power control for the one or more energy classes and/or power states of energy-harvesting devices (e.g., because a time for a UE 115 to apply a CBR measurement to a power control may be different from one UE energy class or power state to another). For example, if a UE 115 (e.g., UE 115-a) is in a powered off state, the UE 115 may be exempted from performing channel sensing, including CBR and/or CR measurements. Similarly, a time at which power control associated with CBR and/or CR is applied (e.g., a time N) may be different for different energy classes, power states, or combinations thereof.

CBR and/or CR measurements may be configured (e.g., according to the one or more timing parameters) to be performed at time periods (e.g., slots) in which a UE 115 is at one or more defined power states (e.g., charging rate, amount of power), rather than all power states. As such, a CBR or CR computation may consider measurements occurring during the one or more defined power states.

Additionally, or alternatively, if UE 115-a belongs to an energy class or power state that is exempt from channel sensing, network entity 105-a may group UE 115-a with a non-energy-harvesting, or helper, UE 115 (e.g., UE 115-b) to assist UE 115-a with channel sensing, CBR measurements, and other inter-UE coordination. For example, UE 115-a, UE 115-c, or both, may receive an indication from network entity 105-a or another UE 115 indicating for UE 115-c to transmit an indication of channel measurements to UE 115-a. In some cases, network entity 105 may configure a helper UE 115 (e.g., a new helper UE 115, a same helper UE 115) at a beginning of each discontinuous reception (DRX) ON cycle (e.g., at a beginning of the DRX cycle). For example, when UE 115-a receives a wake-up signal indication via its connection with the network entity 105-a (e.g., via the Uu link), network entity 105-a may send an indication (e.g., an identifier (ID)) of the helper UE 115, which may be chosen and/or indicated from a set of UEs 115 in an RRC-connected mode with UE 115-a. Additionally, or alternatively, network entity 105-a may configure UE 115-a with a helper UE 115 that may be within a same zone (e.g., having a same zone ID) as UE 115-a.

In some cases, in addition or as an alternative to network entity 105-a grouping UE 115-a with a helper UE 115 (e.g., UE 115-c), UE 115-a may request for UE 115-c to be a helper UE 115 for UE 115-a. For example, UE 115-a may transmit a request for UE 115-c to send an indication of channel sensing measurements (e.g., results of SCI decoding, channel usage measurements such as CR or CBR measurements) to UE 115-a.

In response to the request from UE 115-a or the indication from network entity 105-a, UE 115-c may perform channel sensing (e.g., associated with the resource selection from the sidelink resource pool, associated with other the channel measurements, or both), may generate the indication of the channel sensing measurements based on the channel sensing, and may transmit the indication of the measurements to UE 115-a (e.g., may perform such actions according to a defined or configured periodicity or time period). In some cases, UE 115-a may receive multiple indications from UE 115-c where each indication indicates a channel measurement determined by UE 115-c. In some cases, UE 115-a may select resources for transmitting the sidelink message 225 based on receiving the indication from UE 115-c.

As described herein, an energy-harvesting UE 115 (e.g., UE 115-a) may include or represent a radio frequency identification (RFID) tag that may operate passively, semi-passively (e.g., a battery or energy storage unit powers the chip), or actively (e.g., includes active components such as a low noise amplifier or a power amplifier). In some cases, an active RFID may perform backscattering and transmit waveform or signals as communications. Additionally or alternatively, an energy-harvesting UE 115 may also include a backscatter-based communications device, among other examples.

In some cases, UE 115-a may not perform both signal reception and signal processing while harvesting energy or while in an energy harvesting mode (e.g., such as in time-switch radio frequency (RF) energy harvesting (RF-EH)). As such, UE 115-a may freeze, extend, reduce, or maintain one or more sensing times (e.g., sensing window time, processing time, resource selection window time) while harvesting energy or while in an energy harvesting mode. In some examples, freezing, extending, reducing, or maintaining the sensing times may be associated with a power state. For example, when UE 115-a operates in a low power state UE 115-a may perform energy harvesting using one type of available energy harvesting currently used by UE 115-a (e.g., solar, RF, laser, or vibration) and may freeze, extend, reduce, or maintain the sensing times based on the low power state. Additionally or alternatively, UE 115-a may not perform data, signaling, or sensing measurement when operating in a low power state and may freeze, extend, reduce, or maintain the sensing times based on the low power state. In some cases, one or more changes to the sensing times may be based on a length of the energy harvesting duration.

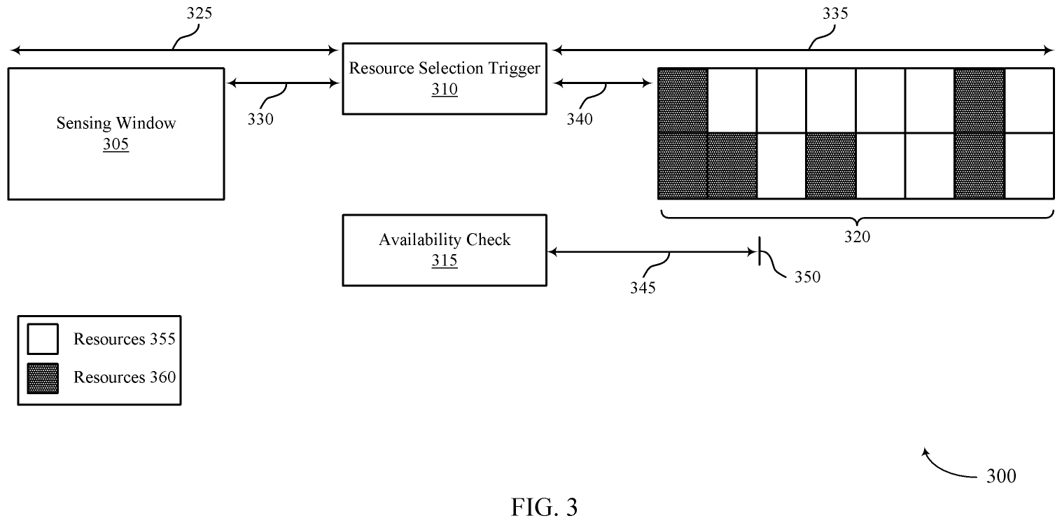

FIG. 3 illustrates an example of a timing diagram 300 that supports energy-based sensing parameters for a sidelink resource pool in accordance with one or more aspects of the present disclosure. The timing diagram 300 may implement or be implemented by aspects of the wireless communications system 100 or 200 as described in FIGS. 1 and 2, respectively. For example, timing diagram 300 may be implemented by an energy-harvesting UE 115, which may be an example of a UE 115 described with reference to FIGS. 1 and 2.

As described with reference to FIGS. 1 and 2, the UE 115 may decode SCI during a sensing window 305 (e.g., SCI reserving sidelink resources), which may be based on one or more parameters. Decoding the sidelink transmissions may include measuring RSRP associated with the SCI, where the UE 115 may determine available resources in a resource selection window 320 based on the measured RSRP values (e.g., as described with reference to FIG. 1). For example, reserved resources 360 (e.g., unavailable resources) may correspond to resources with an RSRP value above the threshold and therefore be used by other UEs 115 for transmission, while the resources 355 may be available to transmit on (e.g., may be unreserved, may be below the RSRP threshold). The UE 115 may sense the SCI during the sensing window 305 and may decode the SCI and/or determine available resources associated with the resource selection window 320 during the time interval 330 (e.g., which may be a UE configured parameter). A time interval 325 may represent a time duration from a beginning of the sensing window 305 a resource selection trigger 310. A network entity 105 may configure the time interval 325, or the time interval 325 may be preconfigured at the UE 115, and for non-energy-harvesting UEs 115 the time interval 325 may be between 100 and 1100 ms.

Based on the decoded sidelink transmissions, the UE 115 may determine candidate sidelink resources in the resource selection window 320 with reserved sidelink resources 360 excluded and the remaining sidelink resources 355 being the candidate sidelink resources for the resource selection window 320. The UE 115 may select one or more of the candidate sidelink resources associated from the resource selection window 320 and perform sidelink communications using the selected sidelink resources at a time 350. The UE 115 may also perform an availability check 315 (e.g., determine that resources are available for transmission) in conjunction with determining the resource selection trigger 310 at some time interval 345 before transmitting at time 350. The availability check 315 may take place before or after the resource selection trigger 310.

The UE 115 may select resources from the resource selection window 320 such that any retransmissions for a packet may occur within a packet delay budget. As such, the time interval 335, from the resource selection trigger 310 to an end of the resource selection window 320, may be less than or equal to a remaining packet delay budget and greater than or equal to a configured minimum time (e.g., T2, mm). For example, T2, mm may be based on a priority of the UE 115 (e.g., in connection with another receiving UE 115). In one example, T2, mm may be determined as 2 where p is a subcarrier spacing (e.g., 15, 30, 60, or 120 kHz). The UE may also process the selected resource during a time interval 340. A time interval 340 from the resource selection trigger 310 to a beginning of the resource selection window 320 may be based on a UE implementation (e.g., based on UE capability, determined by the UE 115).

As described with reference to FIGS. 1 and 2, a network entity 105 may configure channel sensing parameters (e.g., one or more timing parameters) for a sidelink resource pool (e.g., associated with the resources 355 and 360) based on an energy class or power state for energy-harvesting UEs 115. For example, the UE 115 may use shorter or longer time intervals for energy-harvesting purposes (e.g., harvesting between sensing window 305 and resource selection window 320 or time 350), based on an energy class or power state. Accordingly, the one or more timing parameters received from the network entity 105 may define the time interval 325, the T₂, mm parameter associated with time interval 335, or both.

For example, in some cases, the resource selection parameters configured by the network entity 105 (e.g., time interval 325 and time interval 335) may vary significantly between different device energy classes and/or power states, and the configured values may therefore be different for different energy classes and/or power states. For example, the network entity 105 may configure a longer time interval 325 for an energy-harvesting UE 115 with a lower charging capacity or energy-harvesting capacity such that the UE 115 may have sufficient time to recharge before performing resource selection and transmission via the selected resource(s). Accordingly, the network entity 105 may indicate multiple durations corresponding to the time interval 325, where each duration may be associated with an energy class or power state, and the UE 115 may determine which duration to use for time interval 325 based on its energy class or power state.

Similarly, the network entity 105 may configure a longer time interval 335 for an energy-harvesting UE 115 with a lower charging capacity or energy-harvesting capacity such that the UE 115 may have sufficient time to recharge before performing resource selection and transmission via the selected resource(s). Accordingly, the network entity 105 may indicate multiple durations corresponding to the time interval 335, where each duration may be associated with an energy class or power state, and the UE 115 may determine which duration to use for time interval 335 based on its energy class or power state.

In some cases, the network entity 105 may additionally or alternatively define one or more classes of UEs 115 that may perform channel sensing and one or more classes of UEs 115 that are exempt from channel sensing (e.g., in the sensing window 305, for CR or CBR measurements. For example, the network entity 105 may indicate that an energy class with a relatively high charging rate and/or energy-harvesting capability may perform channel sensing and CBR and CR measurements, while a device class with a lower charging rate and/or energy-harvesting capability may be excluded (e.g., exempt) from performing channel sensing and CBR and CR measurements.

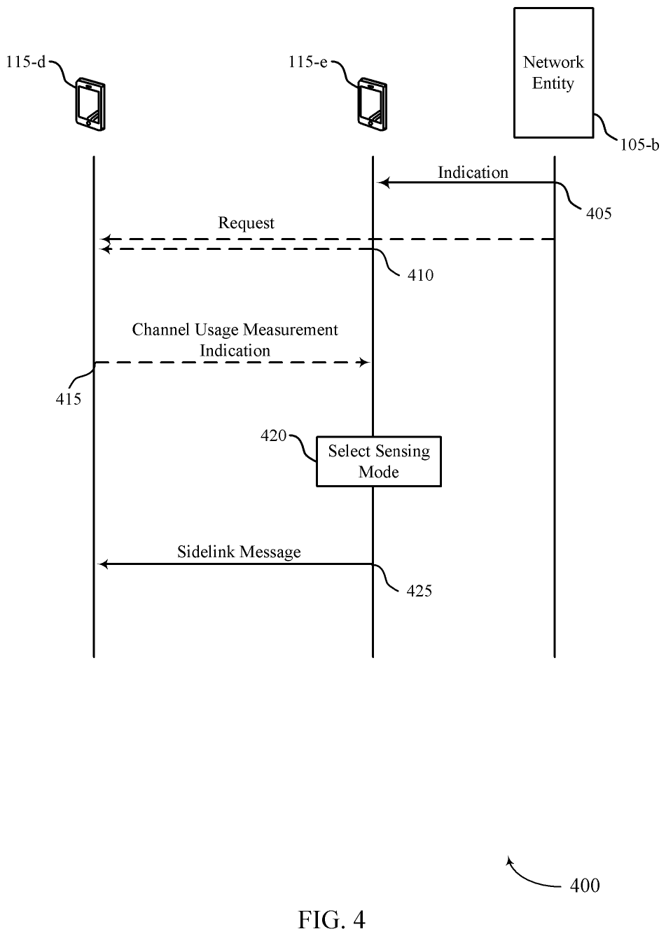

FIG. 4 illustrates an example of a process flow 400 that supports energy-based sensing parameters for a sidelink resource pool in accordance with one or more aspects of the present disclosure. In some examples, the process flow 400 may implement aspects of wireless communication system 100 and wireless communication system 200. The process flow 400 may illustrate examples of a UE 115-d, a UE 115-e, and a network entity 105-b, which may be examples of UE 115 and network entity 105 as described with reference to FIGS. 1-3. For example, UE 115-e may represent an energy-harvesting UE 115, and network entity 105-b may configure one or more timing parameters for a sidelink resource pool that are based on energy class and/or power state.

Alternative examples of the following may be implemented, in which some processes are performed in a different order than described or are not performed. In some cases, processes may include additional features not mentioned below, or further processes may be added. In some cases, different devices may perform the processes shown.

At 405, UE 115-e may receive, from network entity 105-b, an indication of a sidelink resource pool and one or more timing parameters that correspond to an energy class or a power state of UE 115-e (e.g., among other UEs 115, among other energy classes and/or power states). The one or more timing parameters may be associated with performing channel sensing within the sidelink resource pool (e.g., sensing for resource selection, CR measurements, CBR measurements). The indication may include an energy class, power state, or both, which may be associated with a first channel sensing mode associated with performing channel sensing. Additionally, or alternatively, the indication may include an energy class, power state, or both, which may be associated with a second channel sensing mode exempt from performing channel sensing.

In some cases, the timing parameter(s) may include multiple time durations for channel sensing (e.g., sensing for resource selection, CR measurements, CBR measurements), where one or more time durations may be associated with a respective power state, energy class, or combination thereof (e.g., as described with reference to FIGS. 2 and 3).

At 420, UE 115-e may select, based on the one or more timing parameters, between the first channel sensing mode in which UE 115-e is triggered to monitor the sidelink resource pool to perform channel sensing and the second channel sensing mode in which UE 115-e is exempted from channel sensing. In some cases, an energy class associated with the second channel sensing mode indicated at 405 may be one of multiple energy classes and be associated with a lower energy-harvesting capability than the other multiple energy classes. Additionally, or alternatively, a power state associated with the second channel sensing mode indicated at 405 may be one of multiple power states and be associated with a lower available power than the other multiple power states. If UE 115-e operates with the lower energy-harvesting capability or the lower available power state, UE 115-e may select to operate in the second channel sensing mode at 420.

At 410, UE 115-d may receive (e.g., from UE 115-e or network entity 105-b) an indication to send, to UE 115-e, an indication of one more channel usage measurements determined by UE 115-d, a result of channel sensing performed by UE 115-d and associated with resource selection from a sidelink resource pool, or both. In some cases, the indication received by UE 115-d at 410 may be a request for UE 115-d to send the channel usage measurement indication to UE 115-e.

At 415, UE 115-d may transmit, to UE 115-e, an indication including one or more channel usage measurements determined by UE 115-d, where the result of the channel sensing performed by UE 115-d may be associated with resource selection from the sidelink resource pool. In some cases, the channel usage measurements determined by UE 115-d may be transmitted based on receiving a request from UE 115-e or network entity 105-b at 410.

At 425, UE 115-e may transmit, to UE 115-d, a sidelink message via a resource of the sidelink resource pool, where the resource may be selected based on selecting between the first channel sensing mode and the second channel sensing mode at 420. For example, if the first channel sensing mode is selected, UE 115-e may select the resource for the sidelink message based on performing channel sensing according to the one or more timing parameters (e.g., associated with an energy class or power state of UE 115-e). If the second channel sensing mode is selected, UE 115-e may select the resource for the sidelink message randomly or based on information received from UE 115-d.

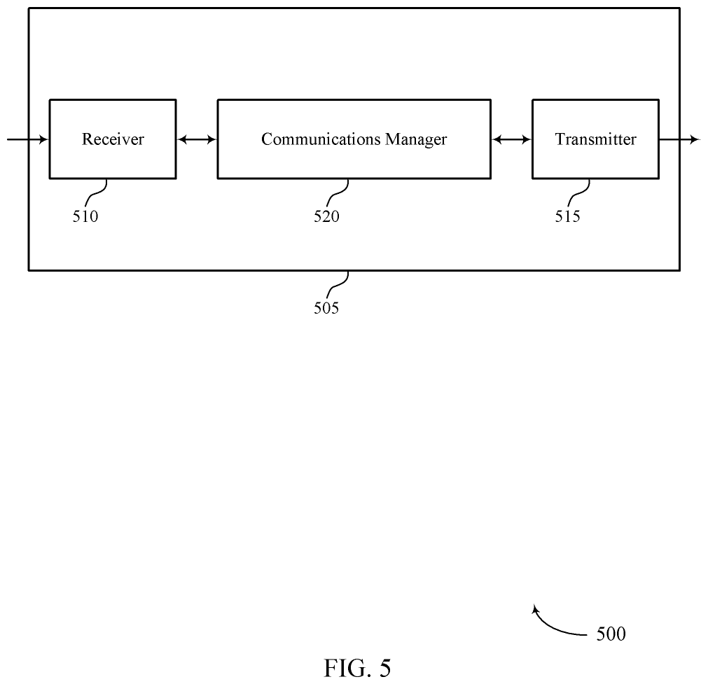

FIG. 5 shows a block diagram 500 of a device 505 that supports energy-based sensing parameters for a sidelink resource pool in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to energy-based sensing parameters for a sidelink resource pool). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to energy-based sensing parameters for a sidelink resource pool). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of energy-based sensing parameters for a sidelink resource pool as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving, from a network entity, an indication of a sidelink resource pool and one or more timing parameters that correspond to an energy class or a power state of the UE, the one or more timing parameters associated with performing channel sensing within the sidelink resource pool. The communications manager 520 may be configured as or otherwise support a means for selecting, based on the one or more timing parameters, between a first channel sensing mode in which the UE is triggered to monitor the sidelink resource pool to perform channel sensing and a second channel sensing mode in which the UE is exempted from channel sensing. The communications manager 520 may be configured as or otherwise support a means for transmitting, to a second UE, a sidelink message via a resource of the sidelink resource pool, the resource selected based on selecting between the first channel sensing mode and the second channel sensing mode.

Additionally, or alternatively, the communications manager 520 may support wireless communication at a second UE in accordance with examples as disclosed herein. For example, the communications manager 520 may be configured as or otherwise support a means for receiving a first indication to send, to a first UE, a second indication of one or more channel usage measurements determined by the second UE, a result of channel sensing performed by the second UE and associated with resource selection from a sidelink resource pool, or both. The communications manager 520 may be configured as or otherwise support a means for transmitting, to the first UE and based on receiving the first indication, the second indication including the one or more channel usage measurements determined by the second UE, the result of the channel sensing performed by the second UE and associated with resource selection from the sidelink resource pool, or both.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources.

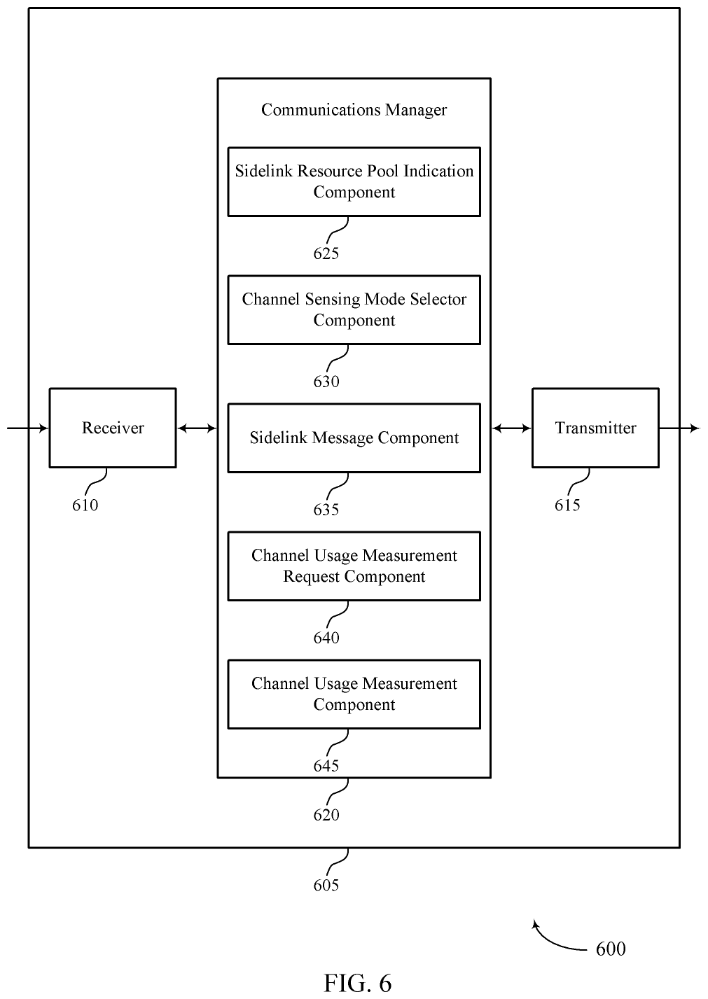

FIG. 6 shows a block diagram 600 of a device 605 that supports energy-based sensing parameters for a sidelink resource pool in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to energy-based sensing parameters for a sidelink resource pool). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to energy-based sensing parameters for a sidelink resource pool). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of energy-based sensing parameters for a sidelink resource pool as described herein. For example, the communications manager 620 may include a sidelink resource pool indication component 625, a channel sensing mode selector component 630, a sidelink message component 635, a channel usage measurement request component 640, a channel usage measurement transmitter component 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The sidelink resource pool indication component 625 may be configured as or otherwise support a means for receiving, from a network entity, an indication of a sidelink resource pool and one or more timing parameters that correspond to an energy class or a power state of the UE, the one or more timing parameters associated with performing channel sensing within the sidelink resource pool. The channel sensing mode selector component 630 may be configured as or otherwise support a means for selecting, based on the one or more timing parameters, between a first channel sensing mode in which the UE is triggered to monitor the sidelink resource pool to perform channel sensing and a second channel sensing mode in which the UE is exempted from channel sensing. The sidelink message component 635 may be configured as or otherwise support a means for transmitting, to a second UE, a sidelink message via a resource of the sidelink resource pool, the resource selected based on selecting between the first channel sensing mode and the second channel sensing mode.

Additionally, or alternatively, the communications manager 620 may support wireless communication at a second UE in accordance with examples as disclosed herein. The channel usage measurement request component 640 may be configured as or otherwise support a means for receiving a first indication to send, to a first UE, a second indication of one or more channel usage measurements determined by the second UE, a result of channel sensing performed by the second UE and associated with resource selection from a sidelink resource pool, or both. The channel usage measurement transmitter component 645 may be configured as or otherwise support a means for transmitting, to the first UE and based on receiving the first indication, the second indication including the one or more channel usage measurements determined by the second UE, the result of the channel sensing performed by the second UE and associated with resource selection from the sidelink resource pool, or both.

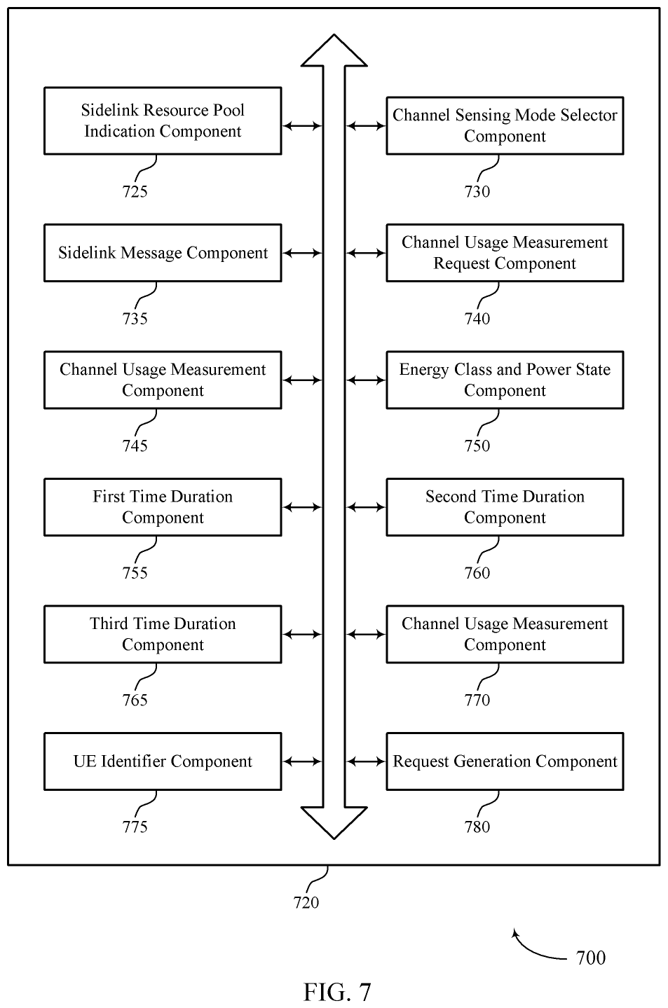

FIG. 7 shows a block diagram 700 of a communications manager 720 that supports energy-based sensing parameters for a sidelink resource pool in accordance with one or more aspects of the present disclosure. The communications manager 720 may be an example of aspects of a communications manager 520, a communications manager 620, or both, as described herein. The communications manager 720, or various components thereof, may be an example of means for performing various aspects of energy-based sensing parameters for a sidelink resource pool as described herein. For example, the communications manager 720 may include a sidelink resource pool indication component 725, a channel sensing mode selector component 730, a sidelink message component 735, a channel usage measurement request component 740, a channel usage measurement component 745, an energy class and power state component 750, a first time duration component 755, a second time duration component 760, a third time duration component 765, a channel usage measurement component 770, a UE identifier component 775, a request generation component 780, or any combination thereof. Each of these components may communicate, directly or indirectly, with one another (e.g., via one or more buses).

The communications manager 720 may support wireless communication at a UE in accordance with examples as disclosed herein. The sidelink resource pool indication component 725 may be configured as or otherwise support a means for receiving, from a network entity, an indication of a sidelink resource pool and one or more timing parameters that correspond to an energy class or a power state of the UE, the one or more timing parameters associated with performing channel sensing within the sidelink resource pool. The channel sensing mode selector component 730 may be configured as or otherwise support a means for selecting, based on the one or more timing parameters, between a first channel sensing mode in which the UE is triggered to monitor the sidelink resource pool to perform channel sensing and a second channel sensing mode in which the UE is exempted from channel sensing. The sidelink message component 735 may be configured as or otherwise support a means for transmitting, to a second UE, a sidelink message via a resource of the sidelink resource pool, the resource selected based on selecting between the first channel sensing mode and the second channel sensing mode.

In some examples, to support receiving the indication of the one or more timing parameters, the energy class and power state component 750 may be configured as or otherwise support a means for receiving an indication of a first energy class, a first power state, or both, that is associated with the second channel sensing mode in which the UE is exempted from channel sensing for selecting resources of the sidelink resource pool.

In some examples, the first energy class is one of a set of multiple defined energy classes and the first energy class is associated with a lower capability for energy-harvesting than one or more other energy classes of the set of multiple defined energy classes. In some examples, the first power state is one of a set of multiple defined power states and the first power state is associated with a lower available power than one or more other power states of the set of multiple defined power states.

In some examples, to support receiving the indication of the one or more timing parameters, the first time duration component 755 may be configured as or otherwise support a means for receiving an indication of a first duration of a first time period between a beginning of a time window for performing channel sensing and a time at which resource selection within the sidelink resource pool is triggered.

In some examples, the one or more timing parameters indicate a set of multiple durations each corresponding to a respective duration for the first time period and each associated with a respective energy class or power state, the set of multiple durations including the first duration.

In some examples, to support receiving the indication of the one or more timing parameters, the second time duration component 760 may be configured as or otherwise support a means for receiving an indication of a second duration associated with a second time period between a time at which resource selection within the sidelink resource pool is triggered and an end of a time window in which resources of the sidelink resource pool are selected.

In some examples, the one or more timing parameters indicate a second set of multiple durations each associated with a respective duration for the second time period and each associated with a respective energy class or power state, the second set of multiple durations including the second duration.

In some examples, to support receiving the indication of the one or more timing parameters, the energy class and power state component 750 may be configured as or otherwise support a means for receiving an indication of a first energy class, a first power state, or both, that is associated with the second channel sensing mode in which the UE is exempted from performing measurements for determining a channel usage ratio within the sidelink resource pool.

In some examples, to support receiving the indication of the one or more timing parameters, the third time duration component 765 may be configured as or otherwise support a means for receiving an indication of a third duration of a third time period associated with performing measurements for determining a channel usage ratio.

In some examples, the one or more timing parameters indicate a set of multiple durations each corresponding to a respective duration for the third time period and each associated with a respective energy class or power state, the set of multiple durations including the third duration.

In some examples, the channel usage measurement component 770 may be configured as or otherwise support a means for receiving, from a second UE, a second indication of one or more channel usage measurements determined by the second UE, a result of channel sensing performed by the second UE and associated with resource selection from the sidelink resource pool, or both, where selecting the resource for transmitting the sidelink message is based on receiving the second indication.

In some examples, the UE identifier component 775 may be configured as or otherwise support a means for receiving, from the network entity or from a third UE, an identifier indicating the second UE, the identifier indicating that the second UE is configured to send the second indication to the UE, where receiving the second indication from the second UE is based on receiving the identifier indicating the second UE.

In some examples, the request generation component 780 may be configured as or otherwise support a means for transmitting, to the second UE, a request for the second UE to send the second indication to the UE, where receiving the second indication from the second UE is based on transmitting the request.

In some examples, to support receiving the second indication from the second UE, the channel usage measurement component 770 may be configured as or otherwise support a means for receiving, from the second UE, a set of multiple indications each indicating one or more respective channel usage measurements determined by the second UE, a respective result of channel sensing performed by the second UE and associated with resource selection from the sidelink resource pool, or both, where the set of multiple indications includes the second indication.

In some examples, the second UE is associated with a same zone identifier as the UE, is in a radio resource control connected state with the UE, or both.

In some examples, the power state of the UE is associated with a current available power at the UE, a current charging rate of the UE, a current powered down state of the UE, or any combination thereof.

In some examples, the energy class of the UE is associated with a class of energy-harvesting performed by the UE.

Additionally, or alternatively, the communications manager 720 may support wireless communication at a second UE in accordance with examples as disclosed herein. The channel usage measurement request component 740 may be configured as or otherwise support a means for receiving a first indication to send, to a first UE, a second indication of one or more channel usage measurements determined by the second UE, a result of channel sensing performed by the second UE and associated with resource selection from a sidelink resource pool, or both. The channel usage measurement component 745 may be configured as or otherwise support a means for transmitting, to the first UE and based on receiving the first indication, the second indication including the one or more channel usage measurements determined by the second UE, the result of the channel sensing performed by the second UE and associated with resource selection from the sidelink resource pool, or both.

In some examples, the UE identifier reception component 775 may be configured as or otherwise support a means for receiving, from a network entity or from a third UE, an identifier indicating the first UE, the identifier indicating that the first UE is configured to receive the second indication from the second UE, where transmitting the second indication to the first UE is based on receiving the identifier indicating the first UE.

In some examples, to support receiving the first indication, the channel usage measurement request component 740 may be configured as or otherwise support a means for receiving, from the first UE, a request for the second UE to send the second indication to the first UE, where transmitting the second indication to the first UE is based on receiving the request.

In some examples, to support transmitting the second indication to the first UE, the channel usage measurement component 745 may be configured as or otherwise support a means for transmitting, to the first UE, a set of multiple indications each indicating one or more respective channel usage measurements determined by the second UE, a respective result of channel sensing performed by the second UE and associated with resource selection from the sidelink resource pool, or both, where the set of multiple indications includes the second indication.

In some examples, the second UE is associated with a same zone identifier as the first UE, is in a radio resource control connected state with the first UE, or both.

In some examples, the first UE is an energy-harvesting UE. In some examples, receiving the first indication is based on an energy-harvesting class or a power state of the first UE.

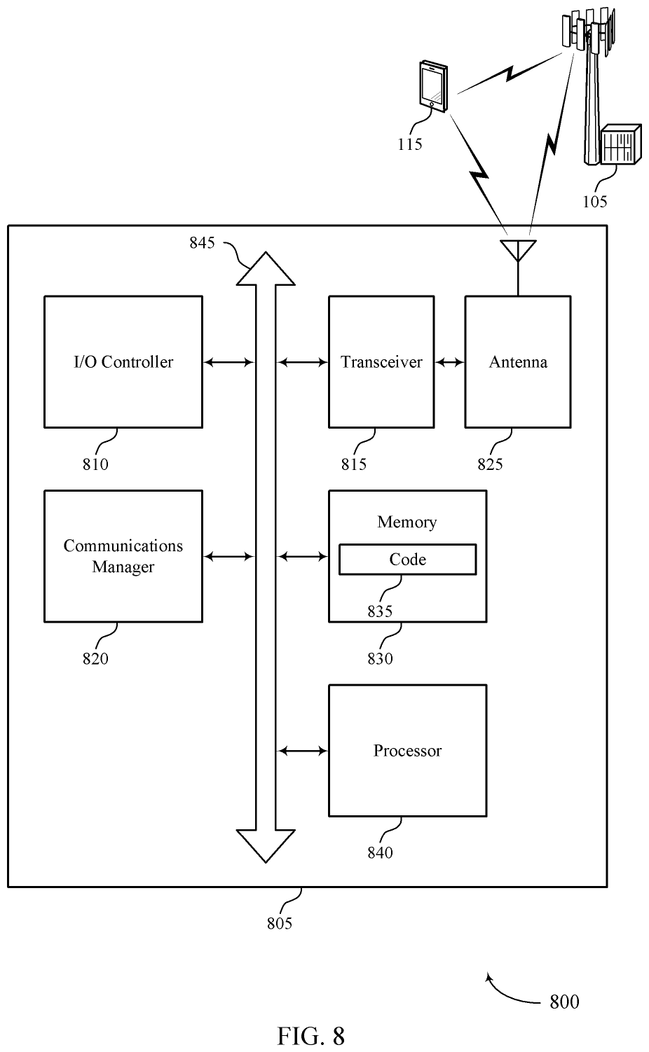

FIG. 8 shows a diagram of a system 800 including a device 805 that supports energy-based sensing parameters for a sidelink resource pool in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting energy-based sensing parameters for a sidelink resource pool). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving, from a network entity, an indication of a sidelink resource pool and one or more timing parameters that correspond to an energy class or a power state of the UE, the one or more timing parameters associated with performing channel sensing within the sidelink resource pool. The communications manager 820 may be configured as or otherwise support a means for selecting, based on the one or more timing parameters, between a first channel sensing mode in which the UE is triggered to monitor the sidelink resource pool to perform channel sensing and a second channel sensing mode in which the UE is exempted from channel sensing. The communications manager 820 may be configured as or otherwise support a means for transmitting, to a second UE, a sidelink message via a resource of the sidelink resource pool, the resource selected based on selecting between the first channel sensing mode and the second channel sensing mode.

Additionally, or alternatively, the communications manager 820 may support wireless communication at a second UE in accordance with examples as disclosed herein. For example, the communications manager 820 may be configured as or otherwise support a means for receiving a first indication to send, to a first UE, a second indication of one or more channel usage measurements determined by the second UE, a result of channel sensing performed by the second UE and associated with resource selection from a sidelink resource pool, or both. The communications manager 820 may be configured as or otherwise support a means for transmitting, to the first UE and based on receiving the first indication, the second indication including the one or more channel usage measurements determined by the second UE, the result of the channel sensing performed by the second UE and associated with resource selection from the sidelink resource pool, or both.

By including or configuring the communications manager 820 in accordance with examples as described herein, the device 805 may support techniques for improved communication reliability, reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of energy-based sensing parameters for a sidelink resource pool as described herein, or the processor 840 and the memory 830 may be otherwise configured to perform or support such operations.

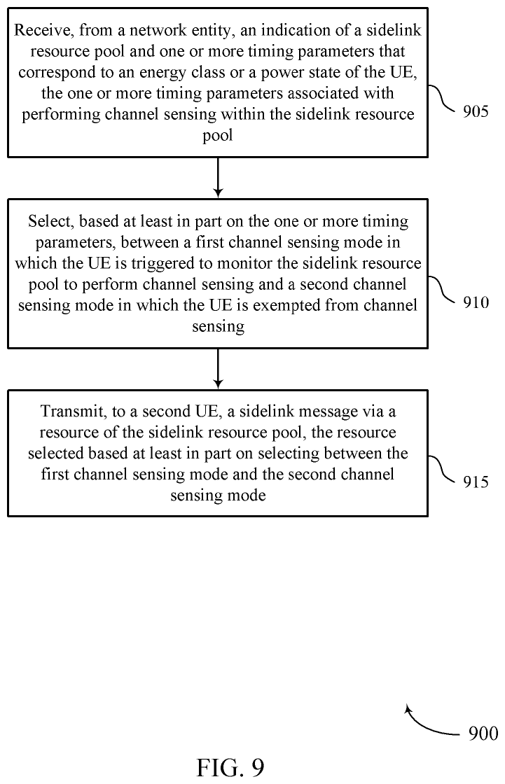

FIG. 9 shows a flowchart illustrating a method 900 that supports energy-based sensing parameters for a sidelink resource pool in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, from a network entity, an indication of a sidelink resource pool and one or more timing parameters that correspond to an energy class or a power state of the UE, the one or more timing parameters associated with performing channel sensing within the sidelink resource pool. The operations of 905 may be performed in accordance with examples as disclosed herein. In some examples, aspects of the operations of 905 may be performed by a sidelink resource pool indication component 725 as described with reference to FIG. 7.

At 910, the method may include selecting, based on the one or more timing parameters, between a first channel sensing mode in which the UE is triggered to monitor the sidelink resource pool to perform channel sensing and a second channel sensing mode in which the UE is exempted from channel sensing. The operations of 910 may be performed in accordance with examples as disclosed herein. In some examples, aspects of the operations of 910 may be performed by a channel sensing mode selector component 730 as described with reference to FIG. 7.

At 915, the method may include transmitting, to a second UE, a sidelink message via a resource of the sidelink resource pool, the resource selected based on selecting between the first channel sensing mode and the second channel sensing mode. The operations of 915 may be performed in accordance with examples as disclosed herein. In some examples, aspects of the operations of 915 may be performed by a sidelink message component 735 as described with reference to FIG. 7.

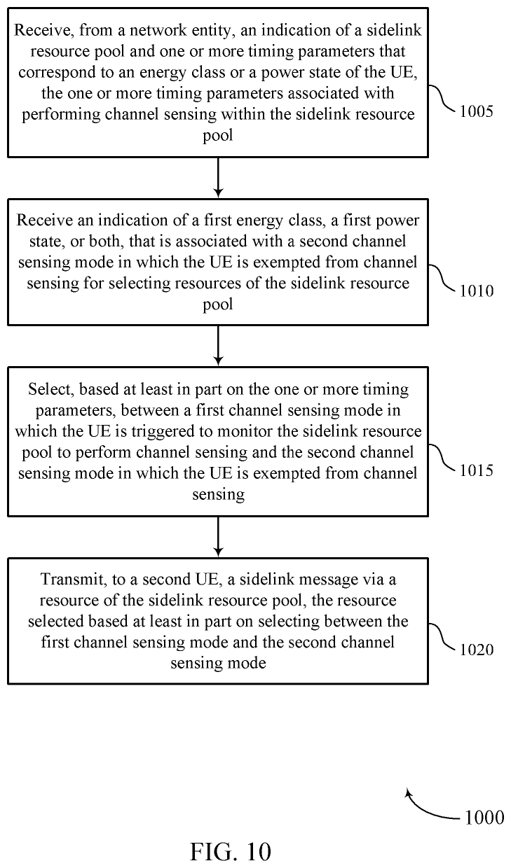

FIG. 10 shows a flowchart illustrating a method 1000 that supports energy-based sensing parameters for a sidelink resource pool in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving, from a network entity, an indication of a sidelink resource pool and one or more timing parameters that correspond to an energy class or a power state of the UE, the one or more timing parameters associated with performing channel sensing within the sidelink resource pool. The operations of 1005 may be performed in accordance with examples as disclosed herein. In some examples, aspects of the operations of 1005 may be performed by a sidelink resource pool indication component 725 as described with reference to FIG. 7.

At 1010, the method may include receiving an indication of a first energy class, a first power state, or both, that is associated with a second channel sensing mode in which the UE is exempted from channel sensing for selecting resources of the sidelink resource pool. The operations of 1010 may be performed in accordance with examples as disclosed herein. In some examples, aspects of the operations of 1010 may be performed by an energy class and power state component 750 as described with reference to FIG. 7.

At 1015, the method may include selecting, based on the one or more timing parameters, between a first channel sensing mode in which the UE is triggered to monitor the sidelink resource pool to perform channel sensing and the second channel sensing mode in which the UE is exempted from channel sensing. The operations of 1015 may be performed in accordance with examples as disclosed herein. In some examples, aspects of the operations of 1015 may be performed by a channel sensing mode selector component 730 as described with reference to FIG. 7.

At 1020, the method may include transmitting, to a second UE, a sidelink message via a resource of the sidelink resource pool, the resource selected based on selecting between the first channel sensing mode and the second channel sensing mode. The operations of 1020 may be performed in accordance with examples as disclosed herein. In some examples, aspects of the operations of 1020 may be performed by a sidelink message component 735 as described with reference to FIG. 7.

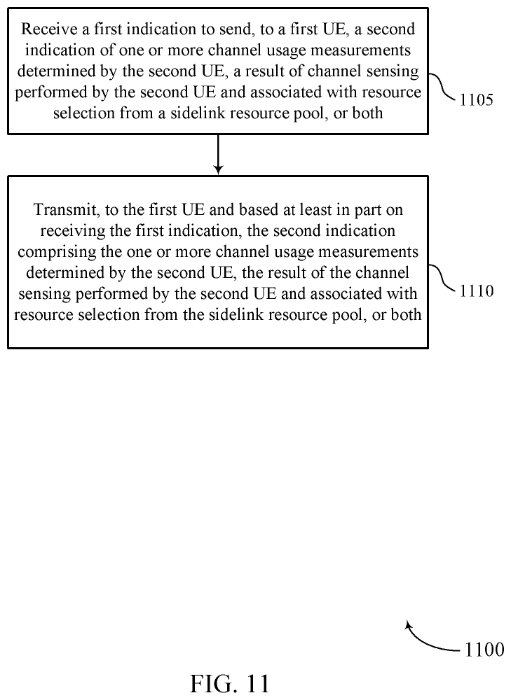

FIG. 11 shows a flowchart illustrating a method 1100 that supports energy-based sensing parameters for a sidelink resource pool in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving a first indication to send, to a first UE, a second indication of one or more channel usage measurements determined by the second UE, a result of channel sensing performed by the second UE and associated with resource selection from a sidelink resource pool, or both. The operations of 1105 may be performed in accordance with examples as disclosed herein. In some examples, aspects of the operations of 1105 may be performed by a channel usage measurement request component 740 as described with reference to FIG. 7.

At 1110, the method may include transmitting, to the first UE and based on receiving the first indication, the second indication including the one or more channel usage measurements determined by the second UE, the result of the channel sensing performed by the second UE and associated with resource selection from the sidelink resource pool, or both. The operations of 1110 may be performed in accordance with examples as disclosed herein. In some examples, aspects of the operations of 1110 may be performed by a channel usage measurement component 745 as described with reference to FIG. 7.

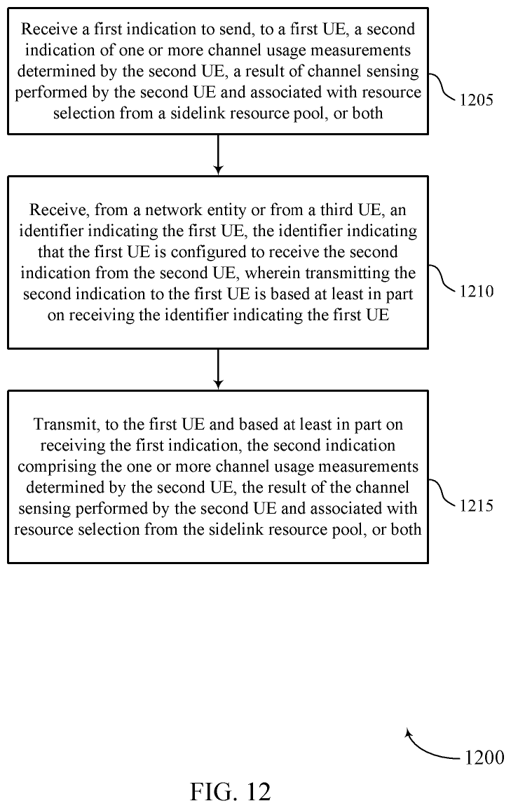

FIG. 12 shows a flowchart illustrating a method 1200 that supports energy-based sensing parameters for a sidelink resource pool in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include receiving a first indication to send, to a first UE, a second indication of one or more channel usage measurements determined by the second UE, a result of channel sensing performed by the second UE and associated with resource selection from a sidelink resource pool, or both. The operations of 1205 may be performed in accordance with examples as disclosed herein. In some examples, aspects of the operations of 1205 may be performed by a channel usage measurement request component 740 as described with reference to FIG. 7.

At 1210, the method may include receiving, from a network entity or from a third UE, an identifier indicating the first UE, the identifier indicating that the first UE is configured to receive the second indication from the second UE, where transmitting the second indication to the first UE is based on receiving the identifier indicating the first UE. The operations of 1210 may be performed in accordance with examples as disclosed herein. In some examples, aspects of the operations of 1210 may be performed by a UE identifier component 775 as described with reference to FIG. 7.

At 1215, the method may include transmitting, to the first UE and based on receiving the first indication, the second indication including the one or more channel usage measurements determined by the second UE, the result of the channel sensing performed by the second UE and associated with resource selection from the sidelink resource pool, or both. The operations of 1215 may be performed in accordance with examples as disclosed herein. In some examples, aspects of the operations of 1215 may be performed by a channel usage measurement component 745 as described with reference to FIG. 7.

The following provides an overview of aspects of the present disclosure:

Aspect 1: A method for wireless communication at a UE, comprising: receiving, from a network entity, an indication of a sidelink resource pool and one or more timing parameters that correspond to an energy class or a power state of the UE, the one or more timing parameters associated with performing channel sensing within the sidelink resource pool; selecting, based at least in part on the one or more timing parameters, between a first channel sensing mode in which the UE is triggered to monitor the sidelink resource pool to perform channel sensing and a second channel sensing mode in which the UE is exempted from channel sensing; and transmitting, to a second UE, a sidelink message via a resource of the sidelink resource pool, the resource selected based at least in part on selecting between the first channel sensing mode and the second channel sensing mode.

Aspect 2: The method of aspect 1, wherein receiving the indication of the one or more timing parameters comprises: receiving an indication of a first energy class, a first power state, or both, that is associated with the second channel sensing mode in which the UE is exempted from channel sensing for selecting resources of the sidelink resource pool.

Aspect 3: The method of aspect 2, wherein the first energy class is one of a plurality of defined energy classes and the first energy class is associated with a lower capability for energy harvesting than one or more other energy classes of the plurality of defined energy classes; and the first power state is one of a plurality of defined power states and the first power state is associated with a lower available power than one or more other power states of the plurality of defined power states.

Aspect 4: The method of any of aspects 1 through 3, wherein receiving the indication of the one or more timing parameters comprises: receiving an indication of a first duration of a first time period between a beginning of a time window for performing channel sensing and a time at which resource selection within the sidelink resource pool is triggered.

Aspect 5: The method of aspect 4, wherein the one or more timing parameters indicate a plurality of durations each corresponding to a respective duration for the first time period and each associated with a respective energy class or power state, the plurality of durations comprising the first duration.

Aspect 6: The method of any of aspects 1 through 5, wherein receiving the indication of the one or more timing parameters comprises: receiving an indication of a second duration associated with a second time period between a time at which resource selection within the sidelink resource pool is triggered and an end of a time window in which resources of the sidelink resource pool are selected.

Aspect 7: The method of aspect 6, wherein the one or more timing parameters indicate a second plurality of durations each associated with a respective duration for the second time period and each associated with a respective energy class or power state, the second plurality of durations comprising the second duration.

Aspect 8: The method of any of aspects 1 through 7, wherein receiving the indication of the one or more timing parameters comprises: receiving an indication of a first energy class, a first power state, or both, that is associated with the second channel sensing mode in which the UE is exempted from performing measurements for determining a channel usage ratio within the sidelink resource pool.

Aspect 9: The method of any of aspects 1 through 8, wherein receiving the indication of the one or more timing parameters comprises: receiving an indication of a third duration of a third time period associated with performing measurements for determining a channel usage ratio.

Aspect 10: The method of aspect 9, wherein the one or more timing parameters indicate a plurality of durations each corresponding to a respective duration for the third time period and each associated with a respective energy class or power state, the plurality of durations comprising the third duration.

Aspect 11: The method of any of aspects 1 through 10, further comprising: receiving, from a second UE, a second indication of one or more channel usage measurements determined by the second UE, a result of channel sensing performed by the second UE and associated with resource selection from the sidelink resource pool, or both, wherein selecting the resource for transmitting the sidelink message is based at least in part on receiving the second indication.

Aspect 12: The method of aspect 11, further comprising: receiving, from the network entity or from a third UE, an identifier indicating the second UE, the identifier indicating that the second UE is configured to send the second indication to the UE, wherein receiving the second indication from the second UE is based at least in part on receiving the identifier indicating the second UE.

Aspect 13: The method of any of aspects 11 through 12, further comprising: transmitting, to the second UE, a request for the second UE to send the second indication to the UE, wherein receiving the second indication from the second UE is based at least in part on transmitting the request.

Aspect 14: The method of any of aspects 11 through 13, wherein receiving the second indication from the second UE comprises: receiving, from the second UE, a plurality of indications each indicating one or more respective channel usage measurements determined by the second UE, a respective result of channel sensing performed by the second UE and associated with resource selection from the sidelink resource pool, or both, wherein the plurality of indications comprises the second indication.

Aspect 15: The method of any of aspects 11 through 14, wherein the second UE is associated with a same zone identifier as the UE, is in a radio resource control connected state with the UE, or both.

Aspect 16: The method of any of aspects 1 through 15, wherein the power state of the UE is associated with a current available power at the UE, a current charging rate of the UE, a current powered down state of the UE, or any combination thereof.

Aspect 17: The method of any of aspects 1 through 16, wherein the energy class of the UE is associated with a class of energy harvesting performed by the UE.

Aspect 18: A method for wireless communication at a second UE, comprising: receiving a first indication to send, to a first UE, a second indication of one or more channel usage measurements determined by the second UE, a result of channel sensing performed by the second UE and associated with resource selection from a sidelink resource pool, or both; and transmitting, to the first UE and based at least in part on receiving the first indication, the second indication comprising the one or more channel usage measurements determined by the second UE, the result of the channel sensing performed by the second UE and associated with resource selection from the sidelink resource pool, or both.

Aspect 19: The method of aspect 18, further comprising: receiving, from a network entity or from a third UE, an identifier indicating the first UE, the identifier indicating that the first UE is configured to receive the second indication from the second UE, wherein transmitting the second indication to the first UE is based at least in part on receiving the identifier indicating the first UE.

Aspect 20: The method of any of aspects 18 through 19, wherein receiving the first indication comprises: receiving, from the first UE, a request for the second UE to send the second indication to the first UE, wherein transmitting the second indication to the first UE is based at least in part on receiving the request.

Aspect 21: The method of any of aspects 18 through 20, wherein transmitting the second indication to the first UE comprises: transmitting, to the first UE, a plurality of indications each indicating one or more respective channel usage measurements determined by the second UE, a respective result of channel sensing performed by the second UE and associated with resource selection from the sidelink resource pool, or both, wherein the plurality of indications comprises the second indication.

Aspect 22: The method of any of aspects 18 through 21, wherein the second UE is associated with a same zone identifier as the first UE, is in a radio resource control connected state with the first UE, or both.

Aspect 23: The method of any of aspects 18 through 22, wherein the first UE is an energy harvesting UE, and receiving the first indication is based at least in part on an energy harvesting class or a power state of the first UE.

Aspect 24: An apparatus for wireless communication at a UE, comprising a at least one processor; memory coupled with the at least one processor; and the memory storing instructions and executable by the at least one processor to cause the UE to perform a method of any of aspects 1 through 17.

Aspect 25: An apparatus for wireless communication at a UE, comprising at least one means for performing a method of any of aspects 1 through 17.

Aspect 26: A non-transitory computer-readable medium storing code for wireless communication at a UE, the code comprising instructions executable by at least one processor to perform a method of any of aspects 1 through 17.

Aspect 27: An apparatus for wireless communication at a second UE, comprising at least one processor; memory coupled with the at least one processor; and the memory storing instructions and executable by the at least one processor to cause the second UE to perform a method of any of aspects 18 through 23.

Aspect 28: An apparatus for wireless communication at a second UE, comprising at least one means for performing a method of any of aspects 18 through 23.

Aspect 29: A non-transitory computer-readable medium storing code for wireless communication at a second UE, the code comprising instructions executable by at least one processor to perform a method of any of aspects 18 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination

The term “determine” or “determining” encompasses a variety of actions and, therefore, “determining” can include calculating, computing, processing, deriving, investigating, looking up (such as via looking up in a table, a database or another data structure), or ascertaining. Also, “determining” can include receiving (e.g., receiving information) or accessing (e.g., accessing data stored in memory). Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled to the at least one processor, the memory storing instructions executable by the at least one processor to cause the UE to:
receive, from a network entity, an indication of a sidelink resource pool and one or more timing parameters that correspond to an energy class or a power state of the UE, the one or more timing parameters associated with performing channel sensing within the sidelink resource pool;
select, based at least in part on the one or more timing parameters, between a first channel sensing mode in which the UE is triggered to monitor the sidelink resource pool to perform channel sensing and a second channel sensing mode in which the UE is exempted from channel sensing; and
transmit, to a second UE, a sidelink message via a resource of the sidelink resource pool, the resource selected based at least in part on selecting between the first channel sensing mode and the second channel sensing mode.

2. The apparatus of claim 1, wherein the instructions to receive the indication of the one or more timing parameters are executable by the at least one processor to cause the apparatus to:
receive an indication of a first energy class, a first power state, or both, that is associated with the second channel sensing mode in which the UE is exempted from channel sensing for selecting resources of the sidelink resource pool.

3. The apparatus of claim 2, wherein:
the first energy class is one of a plurality of defined energy classes and the first energy class is associated with a lower capability for energy-harvesting than one or more other energy classes of the plurality of defined energy classes; and
the first power state is one of a plurality of defined power states and the first power state is associated with a lower available power than one or more other power states of the plurality of defined power states.

4. The apparatus of claim 1, wherein the instructions to receive the indication of the one or more timing parameters are executable by the at least one processor to cause the apparatus to:
receive an indication of a first duration of a first time period between a beginning of a time window for performing channel sensing and a time at which resource selection within the sidelink resource pool is triggered.

5. The apparatus of claim 4, wherein the one or more timing parameters indicate a plurality of durations each corresponding to a respective duration for the first time period and each associated with a respective energy class or power state, the plurality of durations comprising the first duration.

6. The apparatus of claim 1, wherein the instructions to receive the indication of the one or more timing parameters are executable by the at least one processor to cause the apparatus to:
receive an indication of a second duration associated with a second time period between a time at which resource selection within the sidelink resource pool is triggered and an end of a time window in which resources of the sidelink resource pool are selected.

7. The apparatus of claim 6, wherein the one or more timing parameters indicate a second plurality of durations each associated with a respective duration for the second time period and each associated with a respective energy class or power state, the second plurality of durations comprising the second duration.

8. The apparatus of claim 1, wherein the instructions to receive the indication of the one or more timing parameters are executable by the at least one processor to cause the apparatus to:
receive an indication of a first energy class, a first power state, or both, that is associated with the second channel sensing mode in which the UE is exempted from performing measurements for determining a channel usage ratio within the sidelink resource pool.

9. The apparatus of claim 1, wherein the instructions to receive the indication of the one or more timing parameters are executable by the at least one processor to cause the apparatus to:
receive an indication of a third duration of a third time period associated with performing measurements for determining a channel usage ratio.

10. The apparatus of claim 9, wherein the one or more timing parameters indicate a plurality of durations each corresponding to a respective duration for the third time period and each associated with a respective energy class or power state, the plurality of durations comprising the third duration.

11. The apparatus of claim 1, wherein the instructions are further executable by the at least one processor to cause the apparatus to:
receive, from a second UE, a second indication of one or more channel usage measurements determined by the second UE, a result of channel sensing performed by the second UE and associated with resource selection from the sidelink resource pool, or both, wherein selecting the resource for transmitting the sidelink message is based at least in part on receiving the second indication.

12. The apparatus of claim 11, wherein the instructions are further executable by the at least one processor to cause the apparatus to:
receive, from the network entity or from a third UE, an identifier indicating the second UE, the identifier indicating that the second UE is configured to send the second indication to the UE, wherein receiving the second indication from the second UE is based at least in part on receiving the identifier indicating the second UE.

13. The apparatus of claim 11, wherein the instructions are further executable by the at least one processor to cause the apparatus to:
transmit, to the second UE, a request for the second UE to send the second indication to the UE, wherein receiving the second indication from the second UE is based at least in part on transmitting the request.

14. The apparatus of claim 11, wherein the instructions to receive the second indication from the second UE are executable by the at least one processor to cause the apparatus to:
receive, from the second UE, a plurality of indications each indicating one or more respective channel usage measurements determined by the second UE, a respective result of channel sensing performed by the second UE and associated with resource selection from the sidelink resource pool, or both, wherein the plurality of indications comprises the second indication.

15. The apparatus of claim 11, wherein the second UE is associated with a same zone identifier as the UE, is in a radio resource control connected state with the UE, or both.

16. The apparatus of claim 1, wherein the power state of the UE is associated with a current available power at the UE, a current charging rate of the UE, a current powered down state of the UE, or any combination thereof.

17. The apparatus of claim 1, wherein the energy class of the UE is associated with a class of energy-harvesting performed by the UE.

18. An apparatus for wireless communication at a second user equipment (UE), comprising:
at least one processor; and
memory coupled to the at least one processor, the memory storing instructions executable by the at least one processor to cause the second UE to:
receive a first indication to send, to a first UE, a second indication of one or more channel usage measurements determined by the second UE, a result of channel sensing performed by the second UE and associated with resource selection from a sidelink resource pool, or both; and
transmit, to the first UE and based at least in part on receiving the first indication, the second indication comprising the one or more channel usage measurements determined by the second UE, the result of the channel sensing performed by the second UE and associated with resource selection from the sidelink resource pool, or both.

19. The apparatus of claim 18, wherein the instructions are further executable by the at least one processor to cause the second UE to:
receive, from a network entity or from a third UE, an identifier indicating the first UE, the identifier indicating that the first UE is configured to receive the second indication from the second UE, wherein transmitting the second indication to the first UE is based at least in part on receiving the identifier indicating the first UE.

20. The apparatus of claim 18, wherein the instructions to receive the first indication are executable by the at least one processor to cause the second UE to:
receive, from the first UE, a request for the second UE to send the second indication to the first UE, wherein transmitting the second indication to the first UE is based at least in part on receiving the request.

21. The apparatus of claim 18, wherein the instructions to transmit the second indication to the first UE are executable by the at least one processor to cause the second UE to:
transmit, to the first UE, a plurality of indications each indicating one or more respective channel usage measurements determined by the second UE, a respective result of channel sensing performed by the second UE and associated with resource selection from the sidelink resource pool, or both, wherein the plurality of indications comprises the second indication.

22. The apparatus of claim 18, wherein the second UE is associated with a same zone identifier as the first UE, is in a radio resource control connected state with the first UE, or both.

23. The apparatus of claim 18, wherein:
the first UE is an energy-harvesting UE, and
receiving the first indication is based at least in part on an energy-harvesting class or a power state of the first UE.

24. A method for wireless communication at a user equipment (UE), comprising:
receiving, from a network entity, an indication of a sidelink resource pool and one or more timing parameters that correspond to an energy class or a power state of the UE, the one or more timing parameters associated with performing channel sensing within the sidelink resource pool;
selecting, based at least in part on the one or more timing parameters, between a first channel sensing mode in which the UE is triggered to monitor the sidelink resource pool to perform channel sensing and a second channel sensing mode in which the UE is exempted from channel sensing; and
transmitting, to a second UE, a sidelink message via a resource of the sidelink resource pool, the resource selected based at least in part on selecting between the first channel sensing mode and the second channel sensing mode.

25. The method of claim 24, wherein receiving the indication of the one or more timing parameters comprises:
receiving an indication of a first energy class, a first power state, or both, that is associated with the second channel sensing mode in which the UE is exempted from channel sensing for selecting resources of the sidelink resource pool.

26. The method of claim 25, wherein:
the first energy class is one of a plurality of defined energy classes and the first energy class is associated with a lower capability for energy-harvesting than one or more other energy classes of the plurality of defined energy classes; and
the first power state is one of a plurality of defined power states and the first power state is associated with a lower available power than one or more other power states of the plurality of defined power states.

27. The method of claim 24, wherein receiving the indication of the one or more timing parameters comprises:
receiving an indication of a first duration of a first time period between a beginning of a time window for performing channel sensing and a time at which resource selection within the sidelink resource pool is triggered.

28. A method for wireless communication at a second user equipment (UE), comprising:
receiving a first indication to send, to a first UE, a second indication of one or more channel usage measurements determined by the second UE, a result of channel sensing performed by the second UE and associated with resource selection from a sidelink resource pool, or both; and
transmitting, to the first UE and based at least in part on receiving the first indication, the second indication comprising the one or more channel usage measurements determined by the second UE, the result of the channel sensing performed by the second UE and associated with resource selection from the sidelink resource pool, or both.

29. The method of claim 28, further comprising:
receiving, from a network entity or from a third UE, an identifier indicating the first UE, the identifier indicating that the first UE is configured to receive the second indication from the second UE, wherein transmitting the second indication to the first UE is based at least in part on receiving the identifier indicating the first UE.

30. The method of claim 28, wherein receiving the first indication comprises:
receiving, from the first UE, a request for the second UE to send the second indication to the first UE, wherein transmitting the second indication to the first UE is based at least in part on receiving the request.
